(19) United States
(12) Patent Application Publication
(10) Pub. No.: US 2014/0356237 A1
(43) Pub. Date: Dec. 4, 2014

(54) EXHAUST GAS PURIFICATION APPARATUS FOR INTERNAL COMBUSTION ENGINE

(71) Applicant: Kenji Sakurai, Gotenba-shi (JP)

(72) Inventor: Kenji Sakurai, Gotenba-shi (JP)

(73) Assignee: TOYOTA JIDOSHA KABUSHIKI KAISHA, Toyota-shi (JP)

(21) Appl. No.: 14/377,000

(22) PCT Filed: Feb. 7, 2012
(86) PCT No.: PCT/JP2012/052721

§ 371 Date: Aug. 6, 2014

(51) Int. Cl. B01D 53/94

(52) U.S. Cl. CPC B01D 53/9495
USPC 422/111

(57) ABSTRACT

It is intended to maintain the purification ability as a whole. For this purpose, an exhaust gas purification apparatus comprises a three-way catalyst; an NH₃-producing catalyst; and a selective catalytic reduction NOx catalyst; the catalysts being provided in this order at an exhaust gas passage; and the exhaust gas purification apparatus further comprising a control device which carries out rich spike for lowering an air-fuel ratio of an exhaust gas from a lean air-fuel ratio to a predetermined rich air-fuel ratio; wherein the control device lengthens an interval of the rich spike if a temperature of the three-way catalyst is lower than a threshold value as a lower limit value of a temperature of activation as compared with if the temperature of the three-way catalyst is not less than the threshold value.

### TECHNICAL FIELD

The present invention relates to an exhaust gas purification apparatus for an internal combustion engine.

### BACKGROUND ART

A technique is known, in which a storage reduction NOx catalyst (NOx storage reduction catalyst) (hereinafter referred to as “NSR catalyst” as well) is arranged in an exhaust gas passage of an internal combustion engine. The NSR catalyst occludes (absorbs or stores) NOx contained in the exhaust gas when the oxygen concentration of the inflowing exhaust gas is high, while the NSR catalyst reduces occluded NOx when the oxygen concentration of the inflowing exhaust gas is lowered and a reducing agent exists.

In this context, a technique is known, in which the cycle for alternately changing the air-fuel ratio of the exhaust gas to a rich air-fuel ratio or a lean air-fuel ratio and the air-fuel ratio provided on that occasion are adjusted on the basis of the operation condition of the internal combustion engine, the temperature of the NSR catalyst, and the oxygen storage ability of the NSR catalyst when NOx occluded in the NSR catalyst is reduced (see, for example, Patent Document 1).

According to this technique, the air-fuel ratio of the exhaust gas allowed to flow out from the NSR catalyst can be maintained to the theoretical air-fuel ratio by utilizing the oxygen storage ability during the reduction of NOx. Accordingly, it is possible to reduce the harmful substance (toxic substance) contained in the exhaust gas.

In the meantime, a selective catalytic reduction NOx catalyst (hereinafter referred to as “SCR catalyst” as well) can be provided on the downstream side from a three-way catalyst or the NSR catalyst. The SCR catalyst is a catalyst which selectively reduces NOx by using a reducing agent. Then, HC and H₂, which are contained in the exhaust gas, are reacted with NOx by the aid of the three-way catalyst or the NSR catalyst, and thus NH₃ is produced. NH₃ serves as the reducing agent in relation to the SCR catalyst. However, nothing is referred to in the conventional technique in relation to such a case that the SCR catalyst is provided on the downstream side from the NSR catalyst. For this reason, the control, which is adequate to supply the reducing agent to the SCR catalyst, is not necessarily performed.

For example, a temperature range (temperature area or region) (hereinafter referred to as “temperature window” as well), in which NOx can be purified, exists for each of the NSR catalyst and the SCR catalyst. Further, a situation arises such that even when the temperature of one catalyst is within (inside) the temperature window, the temperature of the other catalyst is out of (outside) the temperature window. In the situation as described above, if any appropriate control is not performed, it is feared that the NOx purification rate may be lowered as an entire system.

### PRECEDING TECHNICAL DOCUMENT

### Patent Document

### Patent Document 1: JP2005-139921A.

### SUMMARY OF THE INVENTION

### Task to be Solved by the Invention

The present invention has been made taking the foregoing problems into consideration, an object of which is to maintain the purification ability as a whole even if the purification ability of one catalyst is lowered when a catalyst for producing NH₃ is provided upstream from a selective catalytic reduction NOx catalyst.

### Solution for the Task

In order to achieve the object described above, according to the present invention, there is provided an exhaust gas purification apparatus for an internal combustion engine, comprising:

an NH₃-producing catalyst which is provided at an exhaust gas passage of the internal combustion engine and which is a catalyst for producing NH₃ from NOx;

a selective catalytic reduction NOx catalyst which is provided at the exhaust gas passage downstream from the NH₃-producing catalyst and which reduces NOx by using NH₃ as a reducing agent;

a detecting unit which detects a temperature of the selective catalytic reduction NOx catalyst; and

a control device which switches an air-fuel ratio of an exhaust gas allowed to flow into the NH₃-producing catalyst to a rich air-fuel ratio or a lean air-fuel ratio on the basis of an amount of NOx occluded by the NH₃-producing catalyst, wherein:

the control device switches the air-fuel ratio of the exhaust gas from the lean air-fuel ratio to the rich air-fuel ratio if the amount of NOx occluded by the NH₃-producing catalyst is smaller than that occluded at a temperature at which NOx can be purified, when the temperature of the selective catalytic reduction NOx catalyst is higher or lower than the temperature at which NOx can be purified.

The NH₃-producing catalyst is, for example, such a catalyst that H₂ and/or HC is/are reacted with NO to produce NH₃. NH₃ is produced when the air-fuel ratio of the exhaust gas is the rich air-fuel ratio. The NH₃-producing catalyst is the catalyst which is capable of saving or retaining NOx. The NH₃-producing catalyst may be, for example, a three-way catalyst or a storage reduction NOx catalyst (NOx storage reduction catalyst) (NSR catalyst). It is enough that the NH₃-producing catalyst has the function to save NOx, and NOx may be saved in any state of, for example, storage (occlusion), adsorption, and adhesion. The following explanation will be made assuming that the NH₃-producing catalyst occludes (stores) NOx. In the NH₃-producing catalyst, the occluded NOx is released when the air-fuel ratio is the rich air-fuel ratio, and NH₃ is produced from the released NOx. Further, the selective catalytic reduction NOx catalyst (SCR catalyst) adsorbs NH₃ produced by the aid of the NH₃-producing catalyst, and NOx is reduced with NH₃.

Therefore, when the air-fuel ratio of the exhaust gas is the rich air-fuel ratio when NOx is occluded by the NH₃-producing catalyst, then NH₃ is produced from NOx by the aid of the NH₃-producing catalyst. Accordingly, NOx can be removed from the NH₃-producing catalyst. Further, when the air-fuel ratio of the exhaust gas is the rich air-fuel ratio, HC or the like, which is the reducing agent, can be supplied to the NH₃-producing catalyst thereby. NOx, which has been occluded by the NH₃-producing catalyst, is reduced by the reducing agent. That is, it is also possible to say that NOx is purified by the NH₃-producing catalyst by providing the rich air-fuel ratio.

In the meantime, when the SCR catalyst is provided on the downstream side from the NH₃-producing catalyst, the temperature of the exhaust gas allowed to flow out from the NH₃-producing catalyst is lowered during the period until the exhaust gas arrives at the SCR catalyst. Therefore, the temperature of the SCR catalyst tends to be lowered with ease as compared with the temperature of the NH₃-producing catalyst. In general, the temperature window of the SCR catalyst is lower than the temperature window of the NH₃-producing catalyst. In this context, the longer the distances from the internal combustion engine are, the lower the temperature of the NH₃-producing catalyst and the temperature of the SCR catalyst are. Further, the positions of installation of the respective catalysts can be adjusted in conformity with the temperature windows of the respective catalysts.

However, even when the respective catalysts are installed in conformity with the temperature windows of the respective catalysts, the temperature of the SCR catalyst is out of the temperature window in some cases, for example, depending on the operation state of the internal combustion engine. In such a situation, it is impossible to expect the purification of NOx by the aid of the SCR catalyst. Conversely, if NH₃ is supplied to the SCR catalyst at a high temperature, it is also feared that oxygen and NH₃ may be reacted with each other to produce NOx.

For this reason, the control device suppresses the production of NH₃ in the NH₃-producing catalyst if the temperature of the SCR catalyst is higher than the temperature window or if the temperature of the SCR catalyst is lower than the temperature window. In this context, the larger the amount of NOx occluded by the NH₃-producing catalyst is, the more easily the reaction to produce NH₃ occurs when the rich air-fuel ratio is provided, and hence the larger the amount of produced NH₃ is. Therefore, if the air-fuel ratio of the exhaust gas is switched from the lean to the rich in a state in which the storage amount (occluded amount) of NOx is smaller, then it is possible to decrease the production amount of NH₃. A correlation is provided between the storage amount of NOx and the time for which the lean air-fuel ratio is provided. That is, if the time, for which the lean air-fuel ratio is provided, is shortened, the production amount of NH₃ is decreased. This can be expressed such that the production amount of NH₃ is decreased by shortening the interval for providing the rich air-fuel ratio as well.

On the other hand, if the air-fuel ratio of the exhaust gas is switched from the lean to the rich in a state in which the amount of NOx occluded by the NH₃-producing catalyst is small, the NOx purification rate is raised in the NH₃-producing catalyst. In this context, in order to raise the NOx purification rate in the NH₃-producing catalyst, it is appropriate to maintain a state in which the amount of NOx occluded by the NH₃-producing catalyst is small. For example, it is appropriate to switch the air-fuel ratio of the exhaust gas from the lean to the rich in a state in which the amount of NOx occluded by the NH₃-producing catalyst is small. In this way, when NOx is frequently reduced to rather maintain the state in which the storage amount of NOx is small by shortening the interval for providing the rich air-fuel ratio, it is possible to maintain the state in which NOx is occluded with ease. Therefore, the NOx purification rate is raised in the NH₃-producing catalyst. On the other hand, if the NOx storage amount is increased in the NH₃-producing catalyst, then NOx is hardly occluded, and the NOx purification rate is consequently lowered in the NH₃-producing catalyst.

If the air-fuel ratio is switched from the lean air-fuel ratio to the rich air-fuel ratio in a state in which the storage amount of NOx is small in the NH₃-producing catalyst, the production amount of NH₃ is decreased. Therefore, this situation is disadvantageous to the NOx purification rate of the SCR catalyst. However, if the temperature of the SCR catalyst is higher than the temperature window or the temperature of the SCR catalyst is lower than the temperature window, then it is unnecessary to supply NH₃ to the SCR catalyst. Therefore, no problem arises.

As described above, the condition, which is required to raise the NOx purification rate in the NH₃-producing catalyst, is different from the condition which is required to raise the NOx purification rate in the SCR catalyst. Even when NOx cannot be purified on account of the temperature of the SCR catalyst which is out of the temperature window, it is possible to maintain the high NOx purification rate of the entire system as it is by further raising the NOx purification rate of the NH₃-producing catalyst.

The control device may switch the air-fuel ratio of the exhaust gas from the lean to the rich if the amount of NOx occluded by the NH₃-producing catalyst is relatively large, when the temperature of the SCR catalyst is the temperature at which NOx can be purified. That is, it is also allowable to lengthen the interval for providing the rich air-fuel ratio. In relation thereto, it is also allowable to lengthen the time in which the lean air-fuel ratio is provided. In this context, it is possible to increase the production amount of NH₃ by switching the air-fuel ratio from the lean air-fuel ratio to the rich air-fuel ratio when the amount of NOx occluded by the NH₃-producing catalyst is large. Accordingly, it is possible to raise the purification rate of NOx of the SCR catalyst.

In the meantime, the larger the number of times of the switching between the lean air-fuel ratio and the rich air-fuel ratio is, the more advanced the deterioration of the NH₃-producing catalyst is. Therefore, it is possible to suppress the deterioration of the NH₃-producing catalyst by lengthening the interval for switching the lean air-fuel ratio and the rich air-fuel ratio. That is, when NOx can be purified by the aid of the SCR catalyst, then the production amount of NH₃ produced by the aid of the NH₃-producing catalyst is increased so that NOx is actively purified by the aid of the SCR catalyst, and thus it is also possible to suppress the deterioration of the NH₃-producing catalyst.

The detecting unit may estimate the temperature of the selective catalytic reduction NOx catalyst on the basis of the temperature of the exhaust gas on the downstream side or the upstream side from the selective catalytic reduction NOx catalyst. Further, the temperature of the exhaust gas, which is provided on the upstream side or the downstream side from the selective catalytic reduction NOx catalyst, may be used as the temperature of the selective catalytic reduction NOx catalyst.

The control device can also determine the timing at which the air-fuel ratio is switched, by using, for example, any other physical quantity correlated with the amount of NOx in place of the amount of NOx occluded by the NH₃-producing catalyst. For example, the added-up value of the intake air amounts, the continuing time of the lean air-fuel ratio, and the target air-fuel ratio set when the lean air-fuel ratio is provided are correlated with the amount of NOx occluded by the NH₃-producing catalyst. For example, the air-fuel ratio may be switched from the lean air-fuel ratio to the rich air-fuel ratio if the added-up value of the intake air amounts of the internal combustion engine is smaller than that provided at the temperature at which NOx can be purified, when the temperature of the SCR catalyst is higher or lower than the temperature at which NOx can be purified. Alternatively, it is also allowable that the air-fuel ratio is switched to the rich air-fuel ratio in a state in which the time of provision of the lean air-fuel ratio is short. Further alternatively, it is also allowable that the target air-fuel ratio, which is provided when the lean air-fuel ratio is provided, is raised. When the target air-fuel ratio is raised, then the combustion temperature is lowered, and the amount of emission (discharge amount) of NOx from the internal combustion engine is decreased. Therefore, the storage amount of NOx is decreased. Accordingly, even when the time, in which the lean air-fuel ratio is provided, is unchanged, the air-fuel ratio can be switched from the lean air-fuel ratio to the rich air-fuel ratio in a state in which the NOx storage amount is small.

The control device may switch the air-fuel ratio of the exhaust gas from the lean to the rich if the amount of NOx occluded by the NH₃-producing catalyst is large as compared with a situation in which the temperature of the NH₃-producing catalyst is the temperature at which NOx can be purified, if the temperature of the NH₃-producing catalyst is higher or lower than the temperature at which NOx can be purified, when the temperature of the selective catalytic reduction NOx catalyst is the temperature at which NOx can be purified.

In this context, the temperature of the SCR catalyst is within the temperature window in some cases even when the temperature of the NH₃-producing catalyst is out of the temperature window. In such a situation, it is possible to maintain the high NOx purification rate of the entire system as it is if the NOx purification rate of the SCR catalyst is raised. Then, in order to raise the NOx purification rate of the SCR catalyst, it is appropriate that the air-fuel ratio is switched from the lean air-fuel ratio to the rich air-fuel ratio in a state in which the amount of NOx occluded by the NH₃-producing catalyst is relatively large.

The condition as described above is disadvantageous in relation to the NOx purification rate of the NH₃-producing catalyst. However, in the case of the NH₃-producing catalyst, NOx cannot be purified due to the fact that the temperature is out of the temperature window, and hence no problem arises. A larger amount of the reducing agent can be supplied to the SCR catalyst by increasing the amount of NH₃ produced by the NH₃-producing catalyst. Therefore, it is possible to raise the NOx purification rate of the SCR catalyst. For example, even when NOx cannot be fully occluded, and NOx flows out to the downstream on account of the large storage amount of NOx in the NH₃-producing catalyst, then the NOx purification rate of the SCR catalyst is raised owing to the increase in the amount of production of NH₃, and hence the NOx purification rate of the entire system is maintained to be high as it is.

As described above, even when NOx cannot be purified by the aid of the NH₃-producing catalyst, then the NOx purification rate of the SCR catalyst is further raised, and thus it is possible to maintain the high NOx purification rate of the entire system as it is.

In the present invention, the control device can set at least one of a time for which the rich air-fuel ratio is continued and a target air-fuel ratio which is set when the rich air-fuel ratio is provided, on the basis of the amount of NOx occluded by the NH₃-producing catalyst.

When the temperature of the SCR catalyst is within the temperature window, it is also allowable to set at least one of the time for which the rich air-fuel ratio is continued and the target air-fuel ratio which is set when the rich air-fuel ratio is provided so that the production amount of NH₃ is maximally increased. In this context, the larger the amount of NOx occluded by the NH₃-producing catalyst is, the larger the amount of the reducing agent required to be supplied is, until occluded NOx is entirely reduced. Further, in order to produce a larger amount of NH₃, it is necessary that a larger amount of H₂ or HC should be supplied. It is possible to supply a larger amount of HC or the like to the NH₃-producing catalyst by lengthening (prolonging) the time for which the rich air-fuel ratio is provided or by further lowering the target air-fuel ratio.

In the meantime, if the amount of HC supplied to the NH₃-producing catalyst is excessively large, it is feared that HC, which is not fully reacted, may flow out to the downstream. In this context, in view of only the increase in the production amount of NH₃, it is appropriate that the time, for which the rich air-fuel ratio is provided, is relatively long. However, if it is intended to suppress the deterioration of the fuel efficiency (fuel consumption), and/or if it is intended to reduce the amount of outflow of HC and/or CO, then it is appropriate that the time, for which the rich air-fuel ratio is provided, is relatively short. Therefore, at least one of the time for which the rich air-fuel ratio is continued and the target air-fuel ratio which is set when the rich air-fuel ratio is provided may be set depending on whether the preference is given to the production of NH₃ or the reduction of the amount of emission of HC and/or CO or the deterioration of fuel efficiency (fuel consumption).

Further, in the present invention, the control device can correct the temperature at which NOx can be purified, on the basis of a degree of deterioration of the selective catalytic reduction NOx catalyst.

In this context, as for the NH₃-producing catalyst and the SCR catalyst respectively, the larger the degree of deterioration is, the narrower the temperature window is. Therefore, when the temperature, at which NOx can be purified, is corrected on the basis of the degree of deterioration, it is possible to switch the air-fuel ratio at a more appropriate timing.

Further, in the present invention, the control device can increase an amount of NOx allowed to flow into the NH₃-producing catalyst or a concentration of NOx, if the temperature of the selective catalytic reduction NOx catalyst is the temperature at which NOx can be purified, as compared with if the temperature of the selective catalytic reduction NOx catalyst is higher than the temperature at which NOx can be purified, when the air-fuel ratio of the exhaust gas is the lean air-fuel ratio.

The combustion temperature of the internal combustion engine is raised, for example, by decreasing the supply amount of the EGR gas, and hence it is possible to increase the amount of emission of NOx from the internal combustion engine. Further, the combustion temperature is raised by allowing the air-fuel ratio to approach the theoretical air-fuel ratio, and hence it is possible to increase the amount of emission of NOx from the internal combustion engine. When the amount of emission of NOx from the internal combustion engine is increased as described above, it is possible to thereby produce a larger amount of NH₃ by the aid of the NH₃-producing catalyst. Therefore, even when the NOx purification rate of the NH₃-producing catalyst is lowered, it is possible to raise the NOx purification rate of the SCR catalyst. Therefore, it is possible to maintain the high NOx purification rate of the entire system as it is.

### Effect of the Invention

According to the present invention, it is possible to maintain the purification ability as a whole even if the purification ability of one catalyst is lowered when the catalyst for producing NH₃ is provided upstream from the selective catalytic reduction NOx catalyst.

### BRIEF DESCRIPTION OF THE DRAWINGS

FIG. 1 shows a schematic arrangement of an internal combustion engine according to an embodiment, an intake system thereof, and an exhaust system thereof.

FIG. 2 shows temperature windows of an NSR catalyst and an SCR catalyst.

FIG. 3 shows the relationship between the interval and the time of the rich spike and the amount of produced NH₃.

FIG. 4 shows the relationship between the interval and the time of the rich spike and the NOx purification rate.

FIG. 5 shows a flow chart illustrating a control flow for the rich spike according to the embodiment.

FIG. 6 shows a time chart illustrating the transition of the air-fuel ratio of the exhaust gas allowed to flow out from the NSR catalyst, the NH₃ concentration, the NOx concentration, the CO concentration, and the HC concentration when the interval of the rich spike is relatively short.

FIG. 7 shows a time chart illustrating the transition of the NOx concentration of the exhaust gas allowed to flow out from the NSR catalyst and the NOx concentration of the exhaust gas allowed to flow out from the SCR catalyst 5 when the rich spike shown in FIG. 6 is performed.

FIG. 8 shows a time chart illustrating the transition of the air-fuel ratio of the exhaust gas allowed to flow out from the NSR catalyst, the NH₃ concentration, the NOx concentration, the CO concentration, and the HC concentration when the interval of the rich spike is relatively long.

FIG. 9 shows a time chart illustrating the transition of the NOx concentration of the exhaust gas allowed to flow out from the NSR catalyst and the NOx concentration of the exhaust gas allowed to flow out from the SCR catalyst when the rich spike shown in FIG. 8 is performed.

FIG. 10 shows another flow chart illustrating a control flow of the rich spike according to the embodiment.

### MODE FOR CARRYING OUT THE INVENTION

A specified embodiment of the exhaust gas purification apparatus for the internal combustion engine according to the present invention will be explained below on the basis of the drawings.

### First Embodiment

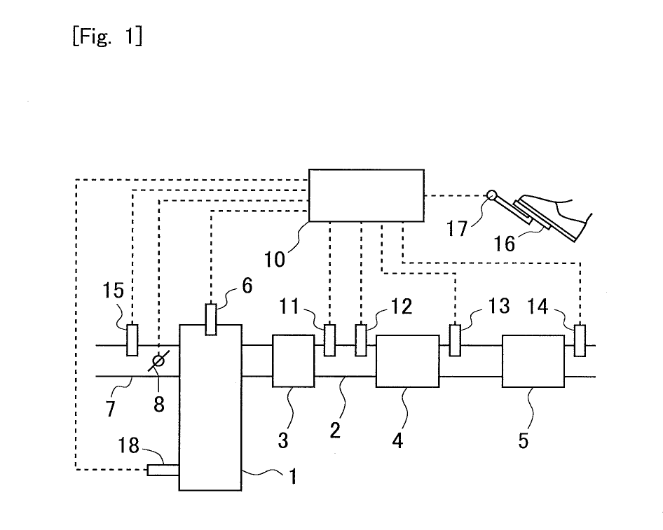

FIG. 1 shows a schematic arrangement of an internal combustion engine according to an embodiment of the present invention, an intake system thereof, and an exhaust system thereof. The internal combustion engine 1 shown in FIG. 1 may be either a gasoline engine or a diesel engine. The internal combustion engine 1 is carried, for example, on a vehicle.

An exhaust gas passage 2 is connected to the internal combustion engine 1. A three-way catalyst 3, a storage reduction NOx catalyst (NOx storage reduction catalyst) 4 (hereinafter referred to as “NSR catalyst 4”), and a selective catalytic reduction NOx catalyst 5 (hereinafter referred to as “SCR catalyst 5”) are provided in this order successively from the upstream side at intermediate positions of the exhaust gas passage 2.

The three-way catalyst 3 purifies NOx, HC, and CO at the maximum efficiency when the catalyst atmosphere resides in the theoretical air-fuel ratio. The three-way catalyst 3 has the oxygen storage ability. That is, oxygen corresponding to an excessive amount is occluded (stored) when the air-fuel ratio of the inflowing exhaust gas is the lean air-fuel ratio, while oxygen corresponding to a shortage amount is released when the air-fuel ratio of the inflowing exhaust gas is the rich air-fuel ratio. Thus, the exhaust gas is purified. Owing to the action of the oxygen storage ability, the three-way catalyst 3 can purify HC, CO, and NOx even when the air-fuel ratio is any air-fuel ratio other than the theoretical air-fuel ratio.

It is also possible to allow the three-way catalyst 3 to have such a function that NOx contained in the exhaust gas is occluded when the oxygen concentration of the inflowing exhaust gas is high, while occluded NOx is reduced when the oxygen concentration of the inflowing exhaust gas is lowered and any reducing agent exist. In this case, it is also allowable that NSR catalyst 4 is absent.

On the other hand, the NSR catalyst 4 occludes NOx contained in the exhaust gas when the oxygen concentration of the inflowing exhaust gas is high, while occluded NOx is reduced when the oxygen concentration of the inflowing exhaust gas is lowered and any reducing agent exists. HC or CO, which is the unburned fuel discharged from the internal combustion engine 1, can be utilized as the reducing agent to be supplied to the NSR catalyst 4.

When the exhaust gas passes through the three-way catalyst 3 or the NSR catalyst 4, then NOx contained in the exhaust gas is reacted with HC or H₂, and ammonia (NH₃) is produced in some cases. For example, when H₂ is produced from CO and H₂O contained in the exhaust gas in accordance with the water gas shift reaction or the steam reforming reaction, H₂ is reacted with NO to produce NH₃ by the aid of the three-way catalyst 3 or the NSR catalyst 4. That is, in this embodiment, the three-way catalyst 3 or the NSR catalyst 4 corresponds to the NH₃-producing catalyst of the present invention. This embodiment will be explained assuming that the NSR catalyst 4 is the NH₃-producing catalyst. However, the consideration can be made in the same way even if it is assumed that the three-way catalyst 3 is the NH₃-producing catalyst.

The SCR catalyst 5 adsorbs the reducing agent beforehand. When NOx is allowed to pass therethrough, the SCR catalyst 5 selectively reduces NOx with the adsorbed reducing agent. NH₃, which is produced by the three-way catalyst 3 or the NSR catalyst 4, can be utilized as the reducing agent to be supplied to the SCR catalyst 5.

A first temperature sensor 11 for detecting the temperature of the exhaust gas and an air-fuel ratio sensor 12 for detecting the air-fuel ratio of the exhaust gas are attached to the exhaust gas passage 2 at positions downstream from the three-way catalyst 3 and upstream from the NSR catalyst. The temperature of the three-way catalyst 3 or the temperature of the NSR catalyst 4 can be detected by the first temperature sensor 11. Further, the air-fuel ratio of the exhaust gas of the internal combustion engine 1 or the air-fuel ratio of the exhaust gas allowed to flow into the NSR catalyst 4 can be detected by the air-fuel ratio sensor 12.

A second temperature sensor 13 for detecting the temperature of the exhaust gas is attached to the exhaust gas passage 2 at a position downstream from the NSR catalyst 4 and upstream from the SCR catalyst 5. The temperature of the NSR catalyst 4 or the temperature of the SCR catalyst 5 can be detected by the second temperature sensor 13.

A third temperature sensor 14 for detecting the temperature of the exhaust gas is attached to the exhaust gas passage 2 at a position downstream from the SCR catalyst 5. The temperature of the SCR catalyst 5 can be detected by the third temperature sensor 14. That is, in this embodiment, the second temperature sensor 13 or the third temperature sensor 14 correspond to the detecting unit of the present invention. The temperatures of the NSR catalyst 4 and the SCR catalyst 5 are changed depending on the operation state of the internal combustion engine 1 (for example, the load exerted on the internal combustion engine 1). Therefore, it is also allowable that the temperatures of the NSR catalyst 4 and the SCR catalyst 5 are estimated in accordance with the operation state of the internal combustion engine 1. Alternatively, temperature sensors may be directly attached to the NSR catalyst 4 and the SCR catalyst 5 to detect the temperatures of the NSR catalyst 4 and the SCR catalyst 5.

It is not necessarily indispensable that all of the sensors described above should be attached. It is also allowable that the sensors described above are appropriately selected and attached.

An injection valve 6 for supplying the fuel to the internal combustion engine 1 is attached to the internal combustion engine 1.

On the other hand, an intake passage 7 is connected to the internal combustion engine 1. A throttle 8, which adjusts the intake air amount of the internal combustion engine 1, is provided at an intermediate position of the intake passage 7. An air flow meter 15, which detects the intake air amount of the internal combustion engine 1, is attached to the intake passage 7 at a position upstream from the throttle 8.

ECU 10, which is an electronic control unit for controlling the internal combustion engine 1, is provided in combination with the internal combustion engine 1 constructed as described above. ECU 10 controls the internal combustion engine 1 in accordance with the operation condition of the internal combustion engine 1 and the request of a driver.

Further, those connected to ECU 10 via electric wirings in addition to the sensors described above include an accelerator opening degree sensor 17 which outputs an electric signal corresponding to a pedaling amount of an accelerator pedal 16 pedaled by the driver to detect the engine load, and a crank position sensor 18 which detects the number of revolutions of the engine. Output signals of various sensors as described above are inputted into ECU 10.

On the other hand, the injection valve 6 and the throttle 8 are connected to ECU 10 via electric wirings. ECU 10 controls the opening/closing timing of the injection valve 6 and the opening degree of the throttle 8.

For example, ECU 10 determines the required intake air amount on the basis of the accelerator opening degree detected by the accelerator opening degree sensor 17 and the number of revolutions of the engine detected by the crank position sensor 18. The opening degree of the throttle 8 is controlled so that the intake air amount, which is detected by the air flow meter 15, becomes the required intake air amount. The injection valve 6 is controlled so as to supply the fuel injection amount corresponding to the intake air amount changed in this situation. The target air-fuel ratio, which is set in this situation, is the air-fuel ratio which is set depending on the operation state of the internal combustion engine 1. The lean burn operation is performed for the internal combustion engine 1 concerning this embodiment. However, the internal combustion engine 1 is operated in some cases in the vicinity of the theoretical air-fuel ratio, for example, during the high load operation. On the other hand, the internal combustion engine 1 is operated in other cases at the rich air-fuel ratio in order to reduce NOx.

ECU 10 carries out the reducing process for reducing NOx occluded by the NSR catalyst 4. When NOx occluded by the NSR catalyst 4 is reduced, then the amount of the fuel injected from the injection valve 6 or the opening degree of the throttle 8 is adjusted, and thus the so-called rich spike is carried out, in which the air-fuel ratio of the exhaust gas allowed to flow into the NSR catalyst 4 is lowered to a predetermined rich air-fuel ratio.

The rich spike is carried out when the amount of NOx occluded by the NSR catalyst 4 is a predetermined amount. The amount of NOx occluded by the NSR catalyst 4 is calculated, for example, by adding up a difference between the amount of NOx allowed to flow into the NSR catalyst 4 and the amount of NOx allowed to flow out from the NSR catalyst 4. The amount of NOx allowed to flow into the NSR catalyst 4 and the amount of NOx allowed to flow out from the NSR catalyst 4 can be detected by attaching a sensor. Alternatively, the rich spike may be carried out every time when a predetermined period of time elapses or every time when a predetermined travel distance is provided. In this embodiment, the timing, at which the rich spike is carried out, is changed on the basis of the temperature of the NSR catalyst 4 or the SCR catalyst 5.

In this context, the temperature range (temperature area or region) (hereinafter referred to as “temperature window” as well), in which the exhaust gas can be purified, exists for each of the three-way catalyst 3, the NSR catalyst 4, and the SCR catalyst 5. Further, the temperature of each of the catalysts is changed depending on the length of the part of the exhaust gas passage 2 disposed on the upstream side from each of the catalysts. That is, the longer the part of the exhaust gas passage 2 disposed on the upstream side from the catalyst is, the lower the temperature of the exhaust gas allowed to flow into the catalyst is, and hence the temperature of the catalyst is lowered. Therefore, when the length of the part of the exhaust gas passage 2 disposed upstream from each of the catalysts is previously adjusted, it is thereby possible to previously set the range in which the temperature of each of the catalysts is changed. Each of the catalysts is installed at such a position that the range of the change of each of the catalysts is overlapped with the temperature window.

However, when the catalysts are carried on a vehicle, the temperature of the exhaust gas and the flow rate of the exhaust gas are changed depending on the driving condition. Therefore, it is difficult to maintain the temperatures of all of the catalysts within the temperature windows under all of the driving conditions. Therefore, even when the temperature of one of the catalysts of the NSR catalyst 4 and the SCR catalyst 5 is within (inside) the temperature window, the temperature of the other catalyst is out of (outside) the temperature window in some cases.

As described above, if the temperature of any one of the catalysts is out of the temperature window, it is feared that the NOx purification rate of the entire system may be lowered. That is, it is feared that the amount of NOx, which flows out to the downstream side from the SCR catalyst 5, may be increased. In relation thereto, in this embodiment, even when the temperature of one of the catalysts of the NSR catalyst 4 and the SCR catalyst 5 is out of the temperature window, the NOx purification rate, which is provided as that of the entire system, is suppressed from being lowered, by raising the NOx purification rate of the other catalyst.

The NOx purification rate is the ratio of the amount of NOx to be purified with respect to the amount of NOx allowed to flow in. The NOx purification rate, which is provided as that of the entire system, is the ratio of the amount of NOx to be purified by the NSR catalyst 4 and the SCR catalyst 5 with respect to the amount of NOx allowed to flow into the NSR catalyst 4.

In this context, it is possible to change the NOx purification rates of the NSR catalyst 4 and the SCR catalyst 5 respectively while scarcely changing the NOx purification rate of the entire system by adjusting the continuing times of the lean air-fuel ratio and the rich air-fuel ratio and/or the target air-fuel ratios at that time. Therefore, even when the temperature of one of the catalysts of the NSR catalyst 4 and the SCR catalyst 5 is out of the temperature window, if the temperature of the other catalyst is within the temperature window, then it is possible to raise the NOx purification rate of the other catalyst.

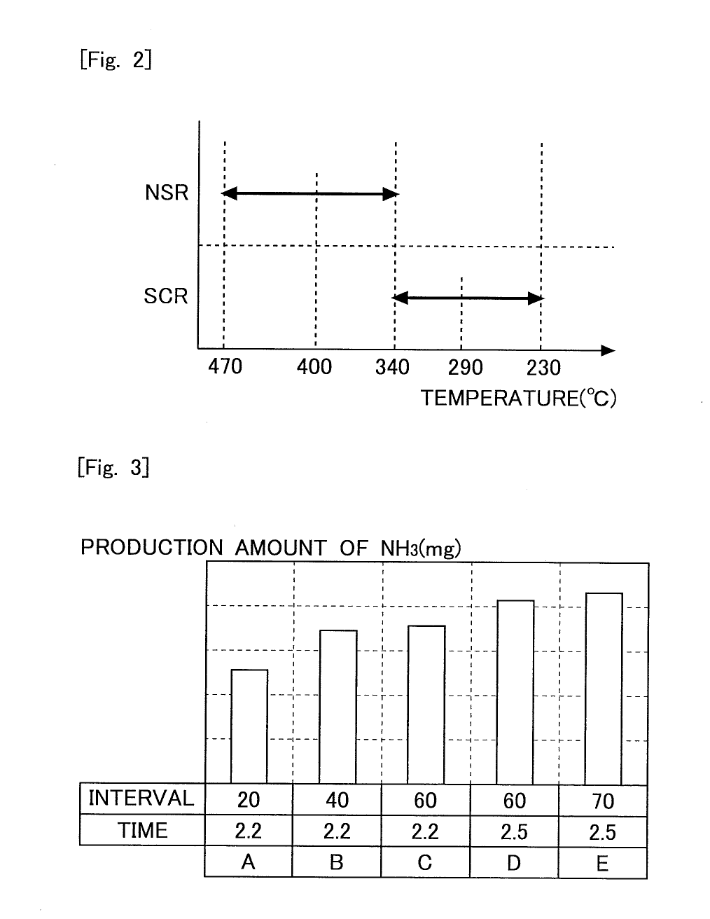

In this context, FIG. 2 shows the temperature windows of the NSR catalyst 4 and the SCR catalyst 5. “NSR” indicates the temperature window of the NSR catalyst 4. Further, “SCR” indicates the temperature window of the SCR catalyst 5. The range, which is indicated by each of the arrows, is the temperature window.

The temperature window of the NSR catalyst 4 ranges, for example, from 340° C. to 470° C., and the NOx purification rate is maximized, for example, at 400° C. On the other hand, the temperature window of the SCR catalyst 5 ranges, for example, from 230° C. to 340° C., and the NOx purification rate is maximized, for example, at 290° C.

The NSR catalyst 4 and the SCR catalyst 5 are installed in consideration of the fact that the temperature of the exhaust gas is lowered in the exhaust gas passage 2. That is, the distance from the internal combustion engine 1 is determined so that the temperature of each of the catalysts is within the temperature window when the operation state of the internal combustion engine 1 is changed. For example, NOx is purified at higher temperatures by the aide of the NSR catalyst 4 as compared with the SCR catalyst 5, and hence the NSR catalyst 4 is provided on the upstream side as compared with the SCR catalyst 5. Further, the NSR catalyst 4 and the SCR catalyst 5 are separated from each other, for example, by 1000 mm. Accordingly, the temperature of the exhaust gas allowed to flow out from the NSR catalyst 4 is lowered, for example, by about 100° C. until arrival at the SCR catalyst 5. It is difficult to move the positions of the respective catalysts after the NSR catalyst 4 and the SCR catalyst 5 are installed as described above.

In this context, a situation is assumed, in which the NSR catalyst 4 and the SCR catalyst 5 are installed so that the temperature of the SCR catalyst 5 is 230° C. which is the lower limit of the temperature window in an operation state in which the temperature of the NSR catalyst 4 is 340° C. which is the lower limit of the temperature window. In this situation, in an operation state in which the temperature of the NSR catalyst 4 is 470° C. which is the upper limit of the temperature window, the temperature of the SCR catalyst 5 is, for example, 370° C., and the temperature of the SCR catalyst 5 is out of the temperature window. That is, it is impossible to purify NOx by the aid of the SCR catalyst 5. On the contrary, if the SCR catalyst 5 has a high temperature, it is also feared that NH₃ and O₂ may be reacted with each other on the SCR catalyst 5 to produce NOx.

On the other hand, for example, the following situation is assumed. That is, the NSR catalyst 4 and the SCR catalyst 5 are installed so that the temperature of the SCR catalyst 5 is 340° C. which is the upper limit of the temperature window even when the temperature of the SCR catalyst 5 is maximally raised, and the temperature of the NSR catalyst 4 in this situation is 440° C. which is within the temperature window. In this case, in an operation state in which the temperature of the SCR catalyst 5 is 230° C. which is the lower limit of the temperature window, the temperature of the NSR catalyst 4 is, for example, 330° C., and the temperature of the NSR catalyst 4 is out of the temperature window.

In this way, even when the temperature of one of the catalysts is out of the temperature window, the temperature of the other catalyst is within the temperature window in some cases. In view of the above, in this embodiment, even when the temperature of one of the catalysts of the NSR catalyst 4 and the SCR catalyst 5 is out of the temperature window, the NOx purification rate, which is provided as that of the entire system, is maintained to be high as it is, by raising the NOx purification rate of the other catalyst.

In this context, FIG. 3 shows the relationship between the interval and the time of the rich spike and the amount of produced NH₃. The vertical axis represents the amount of NH₃ produced when the rich spike is performed once. FIG. 3 shows the amounts of NH₃ produced respectively under the conditions of A to E in each of which the interval or the time of the rich spike differs.

With reference to FIG. 3, the “interval” is the interval of the rich spike, which represents the time (sec) from the completion of the rich spike performed last time to the start of the rich spike performed this time. The “interval” may be the time for which the lean air-fuel ratio is continued or the time for which the lean air-fuel ratio is provided. The interval of the rich spike is correlated with the amount of NOx occluded by the NSR catalyst 4. That is, the longer the interval of the rich spike is, the larger the amount of NOx occluded by the NSR catalyst 4 is.

With reference to FIG. 3, the “time” is the time (sec) for which the rich spike is performed. The “time” may be the time for which the rich air-fuel ratio is continued or the time for which the rich air-fuel ratio is provided. For example, the procedure, in which the lean air-fuel ratio is provided for 20 seconds and then the rich air-fuel ratio is provided for 2.2 seconds, is repeated under the condition of A.

For example, when A and B are compared with each other, then the interval of the rich spike of B is longer than that of A, and the time of the rich spike is identical therebetween. In this context, when the interval of the rich spike is lengthened, the amount of NOx occluded by the NSR catalyst 4 is increased. For this reason, the amount of NH₃, which is produced when the rich spike is performed, is increased. Therefore, the amount of produced NH₃ of B is larger than that of A.

However, when B and C are compared with each other, the production amount of NH₃ is not varied so much, although the interval of the rich spike of C is longer than that of B. In this situation, it is considered that H₂ or HC, which is to be reacted with NOx, is insufficient. That is, it is considered that the amount of produced NH₃ is not increased so much, because the amount of the supplied reducing agent is insufficient, although a large amount of NOx is occluded by the NSR catalyst 4, on account of the fact that the interval of the rich spike is long.

In the next place, when C and D are compared with each other, the production amount of NH₃ is larger in D in which the time of the rich spike is longer, even when the interval of the rich spike is identical. Therefore, it is understood that the production amount of NH₃ is increased by lengthening the time of the rich spike as the interval of the rich spike is more lengthened. For this reason, the production amount of NH₃ is not varied so much, because the time of the rich spike is identical, although the interval of the rich spike of E is longer than that of D.

In this way, the production amount of NH₃ is more increased when the interval of the rich spike is longer, even when the time of the rich spike is identical. Further, the production amount of NH₃ is more increased when the time of the rich spike is longer, even when the interval of the rich spike is identical. According to the fact as described above, it is considered that the production amount of NH₃ is affected by the storage amount of NOx occluded by the NSR catalyst 4. Further, it is also understood that a larger amount of H₂ or HC is appropriately supplied by lengthening the time of the rich spike in order to further increase the production amount of NH₃.

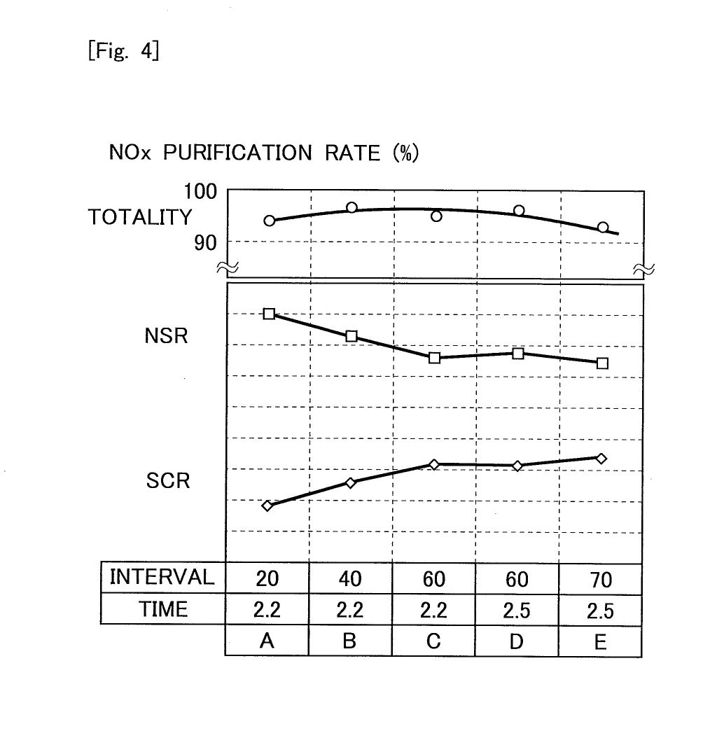

FIG. 4 shows the relationship between the interval and the time of the rich spike and the NOx purification rate. The “totality” means the NOx purification rate obtained by adding up those of the NSR catalyst 4 and the SCR catalyst 5, which is the NOx purification rate provided as that of the entire system. “NSR” indicates the NOx purification rate of the NSR catalyst 4. Further, “SCR” indicates the NOx purification rate of the SCR catalyst 5. The conditions of A to E shown in FIG. 4 correspond to the conditions of A to E shown in FIG. 3.

As seen from the survey of FIG. 4, the NOx purification rate of the NSR catalyst 4 is higher when the interval of the rich spike is shortened. That is, it is possible to raise the NOx purification rate of the NSR catalyst 4 by performing the rich spike in a state in which the amount of NOx occluded by the NSR catalyst 4 is small. On the other hand, the NOx purification rate of the SCR catalyst 5 is higher when the interval of the rich spike is lengthened. That is, it is possible to raise the NOx purification rate of the SCR catalyst 5 by rather producing a larger amount of NH₃ by performing the rich spike in a state in which the amount of NOx occluded by the NSR catalyst 4 is large. For example, even when the total amount of NOx allowed to flow into the NSR catalyst 4 in a predetermined period of time is identical, the production amount of NH₃ is increased in the predetermined period of time when the interval of the rich spike is lengthened, as compared with when the interval of the rich spike is shortened.

In this way, the condition, under which the NOx purification rate is raised in the NSR catalyst 4, is different from the condition under which the NOx purification rate is raised in the SCR catalyst 5. As shown in FIG. 4, even when the interval of the rich spike is changed, the NOx purification rate of the entire system is not changed so much. That is, even when the NOx purification rate of one of the catalysts is lowered, the NOx purification rate of the other catalyst is raised. Therefore, the NOx purification rate of the entire system is maintained to be high as it is. Accordingly, when the interval of the rich spike is changed, it is thereby possible to change the NOx purification rate of each of the catalysts, without changing the NOx purification rate of the entire system. Further, it is possible to change the ratio between the NOx amounts to be purified by the respective catalysts, while scarcely changing the NOx purification rate of the entire system.

In view of the above, in this embodiment, the interval of the rich spike and the time of the rich spike are controlled so that the NOx purification rate of one of the catalysts which is out of the temperature window is lowered and the NOx purification rate of the other catalyst which is within the temperature window is raised. For example, if the temperature of the NSR catalyst 4 is within the temperature window, and the temperature of the SCR catalyst 5 is out of the temperature window, then the interval of the rich spike is shortened as compared with if the temperatures of the both catalysts are within the temperature windows. That is, when the amount of NOx occluded by the NSR catalyst 4 is small, the air-fuel ratio of the exhaust gas is switched from the lean to the rich. Accordingly, the NOx purification rate of the NSR catalyst 4 is raised. Further, the time of the rich spike is determined depending on the interval of the rich spike.

On the other hand, for example, if the temperature of the NSR catalyst 4 is out of the temperature window, and the temperature of the SCR catalyst 5 is within the temperature window, then the interval of the rich spike is lengthened as compared with if the temperatures of the both catalysts are within the temperature windows. That is, when the amount of NOx occluded by the NSR catalyst 4 is large, the air-fuel ratio of the exhaust gas is switched from the lean to the rich. Accordingly, the NOx purification rate of the SCR catalyst 5 is raised.

The relationship among the temperatures of the NSR catalyst 4 and the SCR catalyst 5, the interval of the rich spike, and the time of the rich spike may be previously determined, for example, by means of an experiment so that the NOx purification rate is, for example, maximized. Further, the time of the rich spike may be determined in accordance with the interval of the rich spike.

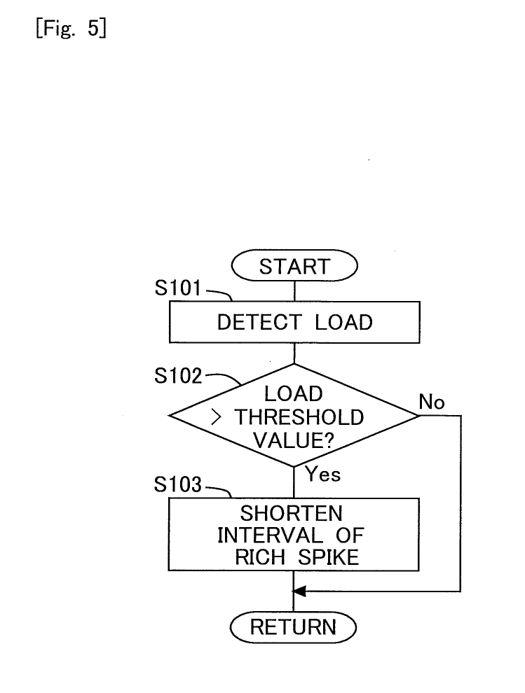

FIG. 5 shows a flow chart illustrating a control flow for the rich spike according to this embodiment. This routine is executed by ECU 10 every time when a predetermined time elapses. This routine is provided on condition that the both catalysts are arranged so that the temperature of the SCR catalyst 5 is the lower limit value of the temperature window when the temperature of the NSR catalyst 4 is the lower limit value of the temperature window. In this embodiment, ECU 10, which executes the routine shown in FIG. 5, corresponds to the control device of the present invention.

In Step S101, the load of the internal combustion engine 1 is detected. For example, the load of the internal combustion engine 1 is detected on the basis of the detection value of the accelerator opening degree sensor 17 or the fuel amount injected from the injection valve 6. The load is detected as a physical quantity which is correlated with the temperatures of the NSR catalyst 4 and the SCR catalyst 5. In this step, it is also allowable to detect the temperatures of the NSR catalyst 4 and the SCR catalyst 5.

In Step S102, it is judged whether or not the load of the internal combustion engine 1 is larger than the threshold value. In this step, it is judged whether or not the temperature of the SCR catalyst 5 exceeds the upper limit of the temperature window. That is, the threshold value can be the load of the internal combustion engine 1 to be provided when the temperature of the SCR catalyst 5 is the upper limit value of the temperature window.

If the affirmative judgment is made in Step S102, the routine proceeds to Step S103. On the other hand, if the negative judgment is made, this routine is completed.

In Step S103, the interval of the rich spike is shortened as compared with that provided if the negative judgment is made in Step S102. That is, when the amount of NOx occluded by the NSR catalyst 4 is small, the air-fuel ratio of the exhaust gas is switched from the lean to the rich. In conformity therewith, the time of the rich spike is set. The interval of the rich spike and the time of the rich spike, which are to be provided in this situation, are previously determined, for example, by means of an experiment so that the NOx purification rate of the NSR catalyst 4 is raised, and the interval of the rich spike and the time of the rich spike are stored in ECU 10 beforehand.

Further, the interval of the rich spike and the time of the rich spike, which are to be provided if the negative judgment is made in Step S102, are previously determined, for example, by means of an experiment so that the NOx can be purified by the NSR catalyst 4 and the SCR catalyst 5, and the interval of the rich spike and the time of the rich spike are stored in ECU 10 beforehand. Further, when the temperature of the SCR catalyst 5 is within the temperature window, it is also allowable that the amount of NOx discharged from the internal combustion engine 1 is increased as compared with when the temperature of the SCR catalyst 5 is out of the temperature window. For example, the combustion temperature is raised by decreasing the supply amount of the EGR gas or allowing the air-fuel ratio to approach the theoretical air-fuel ratio. Therefore, it is possible to increase the amount of emission of NOx from the internal combustion engine 1 or the concentration of NOx. A larger amount of NOx is occluded by the NSR catalyst 4 by increasing the amount of emission of NOx from the internal combustion engine 1 or the concentration of NOx as described above. Therefore, it is possible to produce a larger amount of NH₃. Therefore, it is possible to raise the NOx purification rate of the SCR catalyst 5.

In this way, even when the temperature of one of the catalysts of the NSR catalyst 4 and the SCR catalyst 5 is out of the temperature window, the rich spike is controlled so that the NOx purification rate of the other catalyst is raised. Therefore, it is possible to maintain the high NOx purification rate of the entire system.

In the meantime, in the case of the internal combustion engine 1 in which the lean burn is performed, it is feared that HC and/or CO may be released into the atmospheric air during the rich spike. However, in order to raise the NOx purification rate of the NSR catalyst 4, it is necessary to provide the low air-fuel ratio to such an extent that CO and/or HC is/are discharged from the internal combustion engine 1 during the rich spike. Further, in order to supply NH₃ to the SCR catalyst 5, it is also necessary to perform the rich spike while providing the low air-fuel ratio to such an extent that CO and/or HC is/are discharged from the internal combustion engine 1. Therefore, if it is intended to raise the NOx purification rate, it is feared that CO or HC may be released into the atmospheric air.

In this context, even when CO and/or HC is/are discharged from the internal combustion engine 1 during the rich spike, no problem arises if the total amount thereof is small. It is possible to reduce the amount of emission of CO and/or HC by lengthening the interval of the rich spike. As described above, even when the interval of the rich spike is lengthened, the NOx purification rate is scarcely changed.

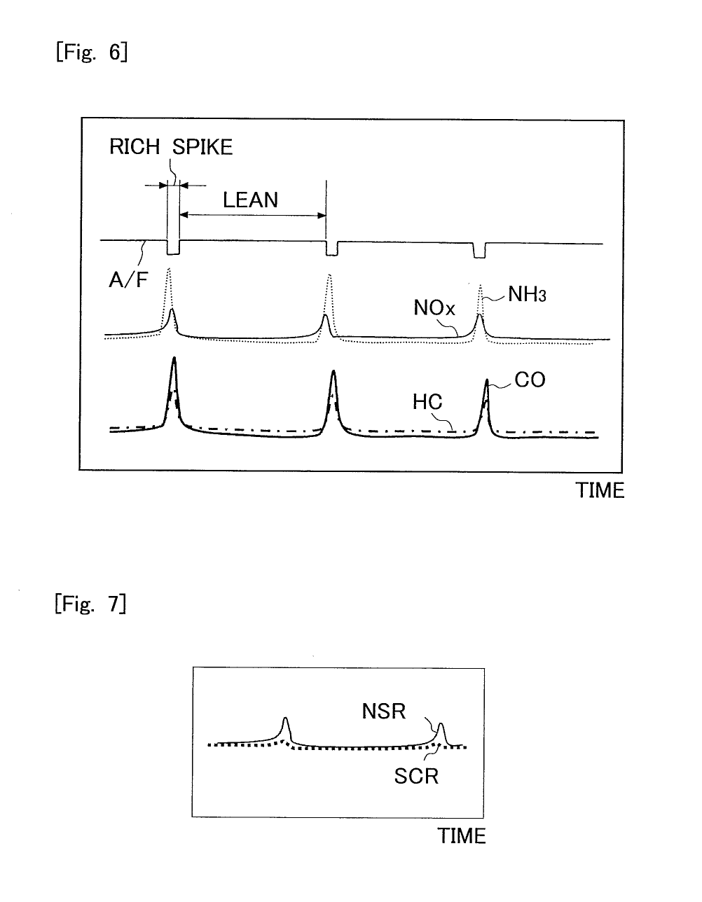

FIG. 6 shows a time chart illustrating the transition of the air-fuel ratio of the exhaust gas allowed to flow out from the NSR catalyst 4, the NH₃ concentration, the NOx concentration, the CO concentration, and the HC concentration when the interval of the rich spike is relatively short. In FIG. 6, “NH₃”, “NOx”, “CO”, and “HC” indicate the NH₃ concentration, the NOx concentration, the CO concentration, and the HC concentration respectively. “A/F” indicates the air-fuel ratio of the exhaust gas. The time represented by “rich spike” is the time for which the rich spike is performed, wherein the air-fuel ratio of the exhaust gas is the rich air-fuel ratio. The air-fuel ratio is the lean air-fuel ratio during the time represented by “lean”. That is, the time, which is represented by “lean”, is the interval of the rich spike.

FIG. 7 shows a time chart illustrating the transition of the NOx concentration of the exhaust gas allowed to flow out from the NSR catalyst 4 and the NOx concentration of the exhaust gas allowed to flow out from the SCR catalyst 5 when the rich spike shown in FIG. 6 is performed.

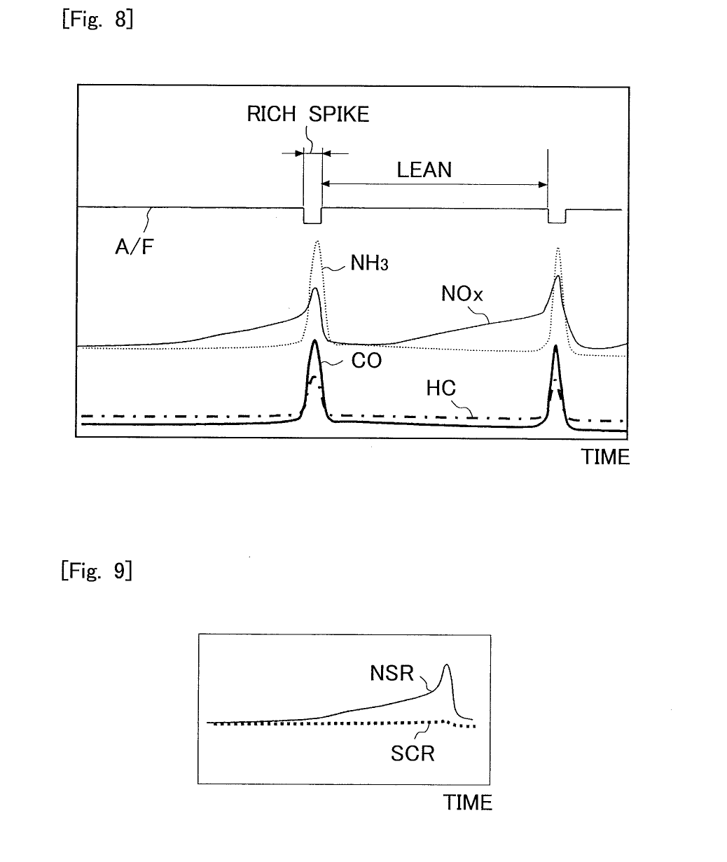

Further, FIG. 8 shows a time chart illustrating the transition of the air-fuel ratio of the exhaust gas allowed to flow out from the NSR catalyst 4, the NH₃ concentration, the NOx concentration, the CO concentration, and the HC concentration when the interval of the rich spike is relatively long, in the same manner as in FIG. 6. FIG. 9 shows a time chart illustrating the transition of the NOx concentration of the exhaust gas allowed to flow out from the NSR catalyst 4 and the NOx concentration of the exhaust gas allowed to flow out from the SCR catalyst 5 when the rich spike shown in FIG. 8 is performed.

When the interval of the rich spike is relatively short, the amount of NOx occluded by the NSR catalyst 4 during the rich spike is small. For this reason, the amount of NOx released during the rich spike and the amount of NH₃ produced during the rich spike are relatively small. Therefore, the NH₃ concentration and the NOx concentration shown in FIG. 6 are relatively low.

It is enough that the time of the rich spike is short as well, because the amount of NOx occluded by the NSR catalyst 4 is small. Therefore, the CO amount and the HC amount, which are discharged by the rich spike performed once, are small. Therefore, the CO concentration and the HC concentration shown in FIG. 6 are relatively low.

On the other hand, when the interval of the rich spike is relatively long, the amount of NOx occluded by the NSR catalyst 4 during the rich spike is relatively large. For this reason, the amount of NOx released during the rich spike and the amount of NH₃ produced during the rich spike are relatively large. Therefore, the NH₃ concentration and the NOx concentration shown in FIG. 8 are relatively high.

Further, the time of the rich spike is lengthened depending on the amount of NOx occluded by the NSR catalyst 4. Therefore, the CO amount and the HC amount, which are discharged by the rich spike performed once, are large. Therefore, the CO concentration and the HC concentration shown in FIG. 8 are relatively high.

However, when the total amount of CO and the total amount of HC, which are discharged during a relatively long identical period for performing the rich spike a plurality of times, are compared between the case shown in FIG. 6 and the case shown in FIG. 8, the amounts, which are provided in the case shown in FIG. 8, are smaller than the amounts which are provided in the case shown in FIG. 6. That is, it is possible to decrease the total amount of CO and the total amount of HC when the interval of the rich spike is relatively long.

As understood from the comparison between FIGS. 7 and 9, even when the interval of the rich spike is changed, the NOx concentration of the exhaust gas allowed to flow out from the SCR catalyst 5 is scarcely changed. That is, even when the interval of the rich spike is changed, the NOx purification rate of the entire system is scarcely changed.

For example, when the activity of the three-way catalyst 3 is low, and it is impossible to expect the purification of HC and/or CO by the three-way catalyst 3, for example, when the internal combustion engine 1 is subjected to the cold start, when the temperature of the internal combustion engine 1 is low, or when the load of the internal combustion engine 1 is low, then it is also possible to reduce the amount(s) of emission of CO and/or HC by lengthening the interval of the rich spike.

In order to decrease the HC amount discharged from the internal combustion engine 1 during the rich spike, it is effective to lengthen the interval of the rich spike and shorten the time of the rich spike. That is, in order to decrease the HC amount discharged from the internal combustion engine 1, it is desirable that the rich spike is performed under the condition of C or E shown in FIG. 4 so that H₂ produced by the rich spike can be maximally utilized to produce a large amount of NH₃.

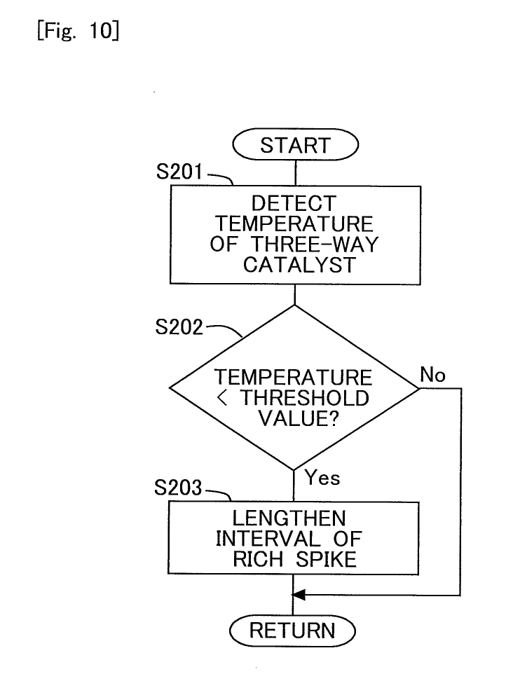

FIG. 10 shows another flow chart illustrating a control flow of the rich spike according to the embodiment of the present invention. This routine is executed by ECU 10 every time when a predetermined time elapses.

In Step S201, the temperature of the three-way catalyst 3 is detected. The temperature of the three-way catalyst 3 may be detected by the first temperature sensor 11. Alternatively, the temperature of the three-way catalyst 3 may be estimated on the basis of the load of the internal combustion engine 1.

In Step S202, it is judged whether or not the temperature of the three-way catalyst 3 is lower than a threshold value which is the lower limit value of the temperature window. In this step, it is judged whether or not the three-way catalyst 3 is activated. That is, in this step, it is judged whether or not a state is given, in which HC and CO are not purified by the three-way catalyst 3. It is also allowable to judge that the temperature of the three-way catalyst 3 is lower than the lower limit value of the temperature window if SV of the exhaust gas is less than a threshold value. The threshold value provided in this situation can be SV of the exhaust gas provided when the temperature of the three-way catalyst 3 is the lower limit value of the temperature window.

If the affirmative judgment is made in Step S202, the routine proceeds to Step S203. On the other hand, if the negative judgment is made, this routine is completed.

In Step S203, the interval of the rich spike is lengthened as compared with that provided if the negative judgment is made in Step S202. In this situation, the interval and the time of the rich spike are set depending on the load of the internal combustion engine 1. The relationship among the load of the internal combustion engine 1 and the interval and the time of the rich spike is determined in order that the HC amount and the CO amount are minimized. The rich spike may be performed, for example, under the condition of C or E described above so that the interval of the rich spike is lengthened and the time of the rich spike is shortened.

In this way, it is possible to purify HC and CO while suppressing the decrease in the NOx purification rate provided as that of the entire system.

In this embodiment, the temperature windows may be corrected depending on the degrees of deterioration of the NSR catalyst 4 and the SCR catalyst 5. The temperature windows of the respective catalysts are narrowed depending on the degrees of deterioration. If the interval of the rich spike and the time of the rich spike are not set depending on the temperature window narrowed as described above, it is feared that the NOx purification rate may be lowered. For example, it is possible to determine the degree of deterioration of each of the catalysts, for example, from the load of the internal combustion engine 1 in the past, the temperature of the NSR catalyst 4 or the SCR catalyst 5 in the past, the travel distance of the vehicle, and the NOx purification rate of the NSR catalyst 4 or the SCR catalyst 5 under a predetermined condition. If the relationship between the degree of deterioration of each of the catalysts and the temperature window is previously determined, for example, by means of an experiment, it is possible to correct the temperature window depending on the degree of deterioration. The NSR catalyst 4 is provided on the upstream side as compared with the SCR catalyst 5. Therefore, the temperature is raised with ease, and hence the deterioration tends to advance in relation to the NSR catalyst 4. For this reason, it is also allowable to raise the NOx purification rate of the SCR catalyst 5 such that the higher the degree of deterioration of the NSR catalyst 4 is, the longer the interval of the rich spike is.

In this embodiment, the air-fuel ratio, which is provided when the lean air-fuel ratio is provided, may be changed in place of the change of the interval of the rich spike. In this context, if the air-fuel ratio is lowered when the lean air-fuel ratio is provided, then the combustion temperature is raised thereby, and hence the amount of emission of NOx from the internal combustion engine 1 is increased. Therefore, even if the interval of the rich spike is not changed, it is possible to change the storage amount of NOx in the NSR catalyst 4 when the air-fuel ratio is switched from the lean air-fuel ratio to the rich air-fuel ratio. That is, the amount of NOx occluded by the NSR catalyst 4 can be increased by lowering the air-fuel ratio when the lean air-fuel ratio is provided. Further, the amount of NOx occluded by the NSR catalyst 4 can be decreased by raising the air-fuel ratio when the lean air-fuel ratio is provided.

In this embodiment, the air-fuel ratio can be also switched on the basis of, for example, any other physical quantity correlated with the amount of NOx occluded by the NSR catalyst 4. For example, the amount of NOx occluded by the NSR catalyst 4 is decreased when the added-up value of the intake air amounts of the internal combustion engine 1 is small. Therefore, it is also allowable to perform the rich spike in accordance with this relationship.

If both of the temperature of the NSR catalyst 4 and the temperature of the SCR catalyst 5 are within the temperature windows, the interval of the rich spike may be either long or short. Further, the interval of the rich spike may be determined in accordance with (1) to (10) described below on the basis of the load of the internal combustion engine 1 or the positions at which the NSR catalyst 4 and the SCR catalyst 5 are installed, and/or the concentration of the sulfur component contained in the fuel.

(1) For example, when the internal combustion engine 1 is operated with a middle load, if the both catalysts are provided so that both of the temperature of the NSR catalyst 4 and the temperature of the SCR catalyst 5 are within the temperature windows, then it is possible to purify NOx by any one of the NSR catalyst 4 and the SCR catalyst 5 when the internal combustion engine 1 is operated with the middle load. Therefore, even when the interval and the time of the rich spike are set in conformity with any one of the catalysts, the NOx purification rate is raised. In such a situation, it is possible to arbitrarily set the interval and the time of the rich spike.

(2) However, even when the internal combustion engine 1 is operated with the middle load, if the concentration of the sulfur component contained in the fuel is high, then the NOx purification rate of the NSR catalyst 4 is lowered due to the sulfur poisoning of the NSR catalyst 4. Therefore, in such a situation, the interval of the rich spike may be lengthened, and the time of the rich spike may be lengthened, in order to preferentially perform the NOx purification by the SCR catalyst 5. That is, it is also appropriate to lengthen the time for which the lean air-fuel ratio is provided. Further, the higher the degree of sulfur poisoning of the NSR catalyst 4 is, the longer the interval of the rich spike may be.

(3) When the NSR catalyst 4 is provided so that the distance from the internal combustion engine 1 to the NSR catalyst 4 is relatively short, there is such a situation that the temperature of the NSR catalyst 4 is higher than the temperature window when the internal combustion engine 1 is operated with a high load. In the situation as described above, the interval of the rich spike may be lengthened, and the time of the rich spike may be lengthened, in order to preferentially perform the NOx purification by the SCR catalyst 5. That is, it is also appropriate to lengthen the time for which the lean air-fuel ratio is provided.

(4) On the other hand, there is also such a situation that the NSR catalyst 4 is provided so that the distance from the internal combustion engine 1 to the NSR catalyst 4 is relatively long, wherein the SCR catalyst 5 is provided so that the distance from the internal combustion engine 1 to the SCR catalyst 5 is relatively short. In the situation as described above, when the internal combustion engine 1 is operated with a high load, then the temperature of the NSR catalyst 4 is within the temperature window, and the temperature of the SCR catalyst 5 is higher than the temperature window in some cases. In the situation as described above, the interval of the rich spike may be shortened, and the time of the rich spike may be shortened, in order to preferentially perform the NOx purification by the NSR catalyst 4. That is, it is also appropriate to shorten the time for which the lean air-fuel ratio is provided.

(5) When the NSR catalyst 4 is provided so that the distance from the internal combustion engine 1 to the NSR catalyst 4 is relatively short, if the concentration of the sulfur component contained in the fuel is high, then there is such a situation that the temperature of the NSR catalyst 4 is higher than the temperature window when the internal combustion engine 1 is operated with a high load. Further, the sulfur poisoning of the NSR catalyst 4 occurs with ease as well. In the situation as described above, the interval of the rich spike may be shortened, and the time of the rich spike may be shortened, so that the storage amount of NOx occluded by the NSR catalyst 4 is decreased. That is, it is also appropriate to shorten the time for which the lean air-fuel ratio is provided.

(6) When the NSR catalyst 4 is provided so that the distance from the internal combustion engine 1 to the NSR catalyst 4 is relatively long, when the SCR catalyst 5 is provided so that the distance from the internal combustion engine 1 to the SCR catalyst 5 is relatively short, if the concentration of the sulfur component contained in the fuel is high, then there is also such a situation that the temperature of the NSR catalyst 4 is within the temperature window even when the internal combustion engine 1 is operated with a high load. However, the NOx purification rate of the NSR catalyst 4 is lowered due to the sulfur poisoning of the NSR catalyst 4. Further, if the temperature of the SCR catalyst 5 is higher than the temperature window, the NOx purification rate of the SCR catalyst 5 is lowered as well. In the situation as described above, it is impossible to expect the NOx purification by the NSR catalyst 4 and the SCR catalyst 5. Therefore, it is also appropriate to purity NOx by the three-way catalyst 3.

(7) When the NSR catalyst 4 and the SCR catalyst 5 are provided so that the distances from the internal combustion engine 1 to the NSR catalyst 4 and the SCR catalyst 5 are relatively short, if the internal combustion engine 1 is operated with a high load, then there is such a situation that the temperature of the NSR catalyst 4 is higher than the temperature window. In this situation, if the temperature of the SCR catalyst 5 is within the temperature window, then the interval of the rich spike may be lengthened, and the time of the rich spike may be lengthened, in order to preferentially perform the NOx purification by the SCR catalyst 5. That is, it is also appropriate to lengthen the time for which the lean air-fuel ratio is provided.

(8) Even when the NSR catalyst 4 and the SCR catalyst 5 are provided so that the distances from the internal combustion engine 1 to the NSR catalyst 4 and the SCR catalyst 5 are relatively short, if the internal combustion engine 1 is operated with a low load, then there is such a situation that the temperature of the NSR catalyst 4 and the temperature of the SCR catalyst 5 are within the temperature windows. In the situation as described above, NOx can be purified by any one of the NSR catalyst 4 and the SCR catalyst 5. Therefore, even when the interval and the time of the rich spike are set in conformity with any one of the catalysts, the NOx purification rate is raised. That is, it is possible to arbitrarily set the interval and the time of the rich spike.

(9) However, when the NSR catalyst 4 and the SCR catalyst 5 are provided so that the distances from the internal combustion engine 1 to the NSR catalyst 4 and the SCR catalyst 5 are relatively short, even when the internal combustion engine 1 is operated with a low load, if the concentration of the sulfur component contained in the fuel is high, then the NOx purification rate of the NSR catalyst 4 is lowered due to the sulfur poisoning of the NSR catalyst 4. Therefore, in such a situation, the interval of the rich spike may be lengthened, and the time of the rich spike may be lengthened, in order to preferentially perform the NOx purification by the SCR catalyst 5. That is, it is also appropriate to lengthen the time for which the lean air-fuel ratio is provided. However, the temperature of the NSR catalyst 4 is relatively high, because the distance from the internal combustion engine 1 to the NSR catalyst 4 is relatively short. For this reason, the sulfur poisoning of the NSR catalyst 4 hardly occurs. Therefore, the interval of the rich spike and the time of the rich spike may be determined so that the NOx purification by the NSR catalyst 4 can be performed in combination as well. The higher the degree of sulfur poisoning of the NSR catalyst 4 is, the longer the interval of the rich spike may be.

(10) When the NSR catalyst 4 is provided so that the distance from the internal combustion engine 1 to the NSR catalyst 4 is relatively short and the internal combustion engine 1 is operated with a low load, when the SCR catalyst 5 is provided so that the temperature of the SCR catalyst is within the temperature window, if the concentration of the sulfur component contained in the fuel is high, then the NOx purification rate of the NSR catalyst 4 is lowered due to the sulfur poisoning of the NSR catalyst 4. On the other hand, the temperature of the SCR catalyst 5 is within the temperature window. Therefore, in such a situation, the interval of the rich spike may be lengthened, and the time of the rich spike may be lengthened, in order to preferentially perform the NOx purification by the SCR catalyst 5. That is, it is also appropriate to lengthen the time for which the lean air-fuel ratio is provided. However, the interval of the rich spike and the time of the rich spike may be determined so that the NOx purification by the NSR catalyst 4 can be performed in combination. Further, the higher the degree of sulfur poisoning of the NSR catalyst 4 is, the longer the interval of the rich spike may be.

NOx can be purified in a wider operating range (operation area or region) as well by arranging the both catalysts so that the temperatures of the NSR catalyst 4 and the SCR catalyst 5 are not simultaneously within the temperature windows, and preferentially utilizing the catalyst which is within the temperature window. That is, it is possible to widen the operating range in which NOx can be purified, by widening the operating range in which the temperature of at least one of the catalysts is within the temperature window.

### PARTS LIST

1: internal combustion engine, 2: exhaust gas passage, 3: three-way catalyst, 4: NOx storage reduction catalyst (NSR catalyst), 5: selective catalytic reduction NOx catalyst (SCR catalyst), 6: injection valve, 7: intake passage, 8: throttle, 10: ECU, 11: first temperature sensor, 12: air-fuel ratio sensor, 13: second temperature sensor, 14: third temperature sensor, 15: air flow meter, 16: accelerator pedal, 17: accelerator opening degree sensor, 18: crank position sensor.

1-4. (canceled)

5. An exhaust gas purification apparatus for an internal combustion engine, comprising:
an NH₃-producing catalyst which is provided at an exhaust gas passage of the internal combustion engine and which is a catalyst for producing NH₃ from NOx;
a selective catalytic reduction NOx catalyst which is provided at the exhaust gas passage downstream from the NH₃-producing catalyst and which reduces NOx by using NH₃ as a reducing agent;
a three-way catalyst which is provided at the exhaust gas passage upstream from the NH₃-producing catalyst;
a detecting unit which detects a temperature of the three-way catalyst; and
a control device which carries out rich spike for lowering an air-fuel ratio of an exhaust gas allowed to flow into the NH₃-producing catalyst from a lean air-fuel ratio to a predetermined rich air-fuel ratio, wherein:
the control device lengthens an interval of the rich spike if the temperature of the three-way catalyst is lower than a threshold value as a lower limit value of a temperature of activation as compared with if the temperature of the three-way catalyst is not less than the threshold value.

6. The exhaust gas purification apparatus for the internal combustion engine according to claim 5, wherein the control device shortens a time for which the rich air-fuel ratio is continued when the rich spike is carried out if the temperature of the three-way catalyst is lower than the threshold value as compared with if the temperature of the three-way catalyst is not less than the threshold value.

7. The exhaust gas purification apparatus for the internal combustion engine according to claim 5, wherein the control device determines the interval of the rich spike depending on a load of the internal combustion engine.
